(19) United States
(12) Patent Application Publication
(10) Pub. No.: US 2016/0231234 A1
(43) Pub. Date: Aug. 11, 2016

(54) APPARATUS AND METHOD TO CONFIRM CLEANING AND MEASURE CLEANING EFFECTIVENESS WITH NEAR-INFRARED SPECTROPHOTOMETER

(71) Applicant: IonField Holdings, LLC, Moorestown, NJ (US)

(72) Inventor: Paul F. Hensley, Moorestown, NJ (US)

(21) Appl. No.: 15/016,793

(22) Filed: Feb. 5, 2016

Related U.S. Application Data
(60) Provisional application No. 62/113,162, filed on Feb. 6, 2015.

(51) Int. Cl. G01N 21/359; B08B 13/00

(52) U.S. Cl. CPC G01N 21/359; B08B 13/00; G01N 2201/10

(57) ABSTRACT

An apparatus and method to clean a substrate and to verify an effectiveness of the cleaning is disclosed. The method includes scanning substrate to generate a pre-cleaning data by using a first mechanism; cleaning substrate by using a second mechanism; scanning substrate to generate a post-cleaning data by using the first mechanism; and generating at least one contamination characteristic based on a comparison between the pre-cleaning data and the post-cleaning data. The contamination characteristic is analyzed for evidence of a contaminant in order to verify effectiveness of the cleaning. Process parameters may be adjusted based upon feedback from the effectiveness of the cleaning.

### CROSS-REFERENCE TO RELATED APPLICATIONS

This application claims the benefit of U.S. Provisional Patent Application Ser. No. 62/113,162, filed on Feb. 6, 2015, entitled “APPARATUS AND USE OF NEAR INFRARED (NIR) SPECTROPHOTOMETER TO CONFIRM PLASMA TREATMENT AND MEASURE CLEANING EFFECTIVENESS”, which is incorporated herein by reference in its entirety.

### BACKGROUND

1. Field

Embodiments of the present invention generally relate to an apparatus and method to clean a substrate and measure the effectiveness of the cleaning. More specifically, embodiments relate to the apparatus and method to detect contaminants on a substrate. Some embodiments relate to the apparatus and method to sense a condition of a substrate after a cleaning. Some embodiments relate to the apparatus and method to sense a condition of a substrate after a cleaning and use of the condition to alter the methods of cleaning.

2. Description of Related Art

Within the disciplines of the clinical, industrial and life science laboratory, scientists perform methods and protocols with small quantities of samples having fluids. These fluids consist of many categories and types with various physical properties. Many times, volumes of the fluid are between a drop (about 25 microliters) and a few nanoliters. There are a number of standard methods employed to transfer fluid and/or liquid compounds from a source by aspirating the liquid from a number of labware such as, a fluid holding device into a fluid dispensing device having a probe, cannula, pin tool or other similar component or plurality of components. The fluid dispensing device and its probes can move, manually or robotically, and then dispensing, from the same probe or plurality of probes, into another fluid holding device, such as a microplate for various purposes such as testing and so forth.

Generally, the probes, unless disposable, are reused from one test to the next. Therefore, devices such as of the fluid dispensing device and the fluid holding device, their probes, or at least the tips of the probes must be cleaned before each test to avoid cross contamination.

Apparatus and methods of cleaning such devices, i.e., the fluid dispensing devices and the fluid holding devices, are known in the art. For example, U.S. Pat. No. 6,724,608, hereby incorporated by reference in its entirety, discusses such methods involving plasma.

These methods and apparatus to clean the fluid dispensing device and the fluid holding device have certain disadvantages. Conventional techniques do not determine whether contaminants are removed from labware or not, and do not effectively measure cleanliness of the fluid dispensing device and the fluid holding device.

There is thus a need for an apparatus and method to clean substrates in a more efficient manner. Further, there is a need for an apparatus and method for effective measurement of substrate cleanliness.

### SUMMARY

Embodiments in accordance with the present disclosure provide an apparatus that can assess the effectiveness of a cleaning apparatus and a cleaning protocol, and/or to assess and track the condition of the substrate cleaned.

In particular, embodiments in accordance with the present disclosure relate to an apparatus for cleaning objects including sensors for detecting any remaining contaminants on a substrate and/or for sensing the condition of the substrate. In some embodiments, the application relates to an apparatus for cleaning labware, including sensors for detecting any remaining contaminant after cleaning and/or assessing the condition of the labware after cleaning. In some embodiments, the labware may be a microplate or a pipette.

Embodiments in accordance with the present invention provide a method to clean a substrate. The method includes scanning the substrate to generate a pre-cleaning data by using a first mechanism; cleaning the substrate by using a second mechanism; scanning the substrate to generate a post-cleaning data by using the first mechanism; and generating at least one contamination characteristic based on a comparison between the pre-cleaning data and the post-cleaning data.

Embodiments in accordance with the present invention further provide an apparatus to clean a substrate. The apparatus includes a scanner to scan the substrate to generate a pre-cleaning data by using a first mechanism. The apparatus further includes a cleaning mechanism to clean the substrate by using a second mechanism. The apparatus includes the scanner further scans the substrate to generate a post-cleaning data by using the first mechanism. The apparatus further includes a processing device to generate at least one contamination characteristic based on a comparison between the pre-cleaning data and the post-cleaning data.

Embodiments in accordance with the present invention further provide a method to clean a substrate. The method includes scanning the substrate to generate a pre-cleaning data by using a first mechanism; cleaning the substrate by using a second mechanism; scanning the substrate to generate a post-cleaning data by using the first mechanism; generating at least one contamination characteristic based on a comparison between the pre-cleaning data and the post-cleaning data; and predicting an effect of the cleaning on the substrate based on the generated at least one contamination characteristic.

Embodiments of the present invention may provide a number of advantages depending on its particular configuration. Embodiments of the present invention may predict an effect of cleaning on a substrate. Further, embodiments may evaluate a useful life cycle of the substrate under treatment (e.g., number of total or remaining cleanings). In addition, embodiments may calculate a predictive effect of an additional treatment via the historical differences between subsequent data as contained in the historical database.

Some embodiments provide a method comprising presenting an identified substrate for cleaning, wherein the identified substrate is associated with recorded NIR spectrophotometric data based on the identified substrate; cleaning the identified substrate; scanning the cleaned identified substrate with an NIR spectrophotomer to obtain new identified substrate NIR data; comparing the new identified substrate NIR data to the recorded NIR spectrophotometric data to identify any non-plate material data or its presence.

Some embodiments further comprise the step of identifying any non-plate material data as indicative of a contaminant.

In some embodiments, the comparing step also accounts for the predicted effect of the cleaning step.

Some embodiments provide a method of evaluating the useful life a substrate to be treated, the method comprising providing a unique identifier to a substrate; subjecting the new identified substrate to NIR spectrophotometry; recording the spectrophotometric data and associating it with the identified new substrate; treating the new identified substrate; subjecting the treated identified substrate to NIR spectrophotometry; determining treatment effect on the treated substrate by comparing the NIR data of the identified new substrate to that of the identified treated substrate.

Some embodiments further comprise subsequently treating the treated identified substrate to yield a subsequently treated substrate; subjecting the subsequently treated substrate to NIR spectrophotometry; determining subsequent treatment effect on the treated identified substrate by comparing the NIR data of the treated identified substrate to that of the subsequently treated identified substrate.

In some embodiments, the subsequent treatment and determining steps are repeated from 1 to 10,000 times to establish an historical database.

In some embodiments, a predictive effect of an additional treatment can be calculated via the historical differences between subsequent NIR data as contained in the historical database.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments in a simplified form as an introduction to the more detailed description presented below. As will be appreciated, other embodiments are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken with the accompanying drawings, and wherein:

FIG. 1 illustrates an isometric view of an apparatus to clean a substrate, according to an embodiment of the present invention;

FIG. 2A depicts a block diagram of a method to scan a substrate, according to an embodiment of the present invention;

FIG. 2B depicts a block diagram of a method to scan a used substrate, according to an embodiment of the present invention;

FIG. 3 depicts a block diagram of a method to update a database based on analysis of data generated from the scanning of a substrate, according to an embodiment of the present invention;

FIG. 4 depicts a flowchart of a method to clean a substrate, according to an embodiment of the present invention; and

FIG. 5 depicts a flowchart of a method to clean a substrate, according to another embodiment of the present invention.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but to the contrary, the present invention is to cover all modification, equivalents and alternatives falling within the spirit and scope of embodiments as disclosed by the specification, whether claimed or unclaimed.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention are illustrated below with exemplary laboratory equipment. Embodiments are not limited to any particular type of laboratory equipment. Those skilled in the art will recognize the disclosed techniques may be used in any laboratory equipment in which it is desirable to detect and clean contaminants.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

A module that performs a function also may be referred to as being configured to perform the function, e.g., a data module that receives data also may be described as being configured to receive data. Configuration to perform a function may include, for example: providing and executing computer code in a processor that performs the function; providing provisionable configuration parameters that control, limit, enable or disable capabilities of the module (e.g., setting a flag, setting permissions, setting threshold levels used at decision points, etc.); providing a physical connection, such as a jumper to select an option, or to enable/disable an option; attaching a physical communication link; enabling a wireless communication link; providing electrical circuitry that is designed to perform the function without use of a processor, such as by use of discrete components and/or non-CPU integrated circuits; energizing a circuit that performs the function (e.g., providing power to a transceiver circuit in order to receive data); and so forth.

The terms “determine”, “calculate” and “compute,” and variations thereof, as used herein, are used interchangeably and include any type of methodology, process, mathematical operation or technique.

Embodiments of the present invention provide an apparatus and method to clean a substrate, confirm the cleaning, and measure effectiveness of the cleaning. In an exemplary embodiment, the substrate is an object that is to be cleaned or treated with the apparatus and the method disclosed in the embodiments. Substrates may be used in clinical, industrial, and/or scientific laboratories as labware. It should be noted, however, that the method and apparatus described herein are adaptable to many devices. Labware may be, but is not restricted to, a sample holding device, a sample handling device, a fluid holding device, a fluid handling device, and the like. The fluid handling device may include, but is not restricted to, a pipette, a tip, a probe, a dropper, and the like. The fluid holding device may include, but is not restricted to, a microplate, a test tube, a microtube, and the like.

The term “plasma” describes a quasi-neutral gas of charged and neutral species characterized by a collective behavior governed by coulomb interactions. Plasma typically is obtained when sufficient energy, higher than the ionization energy of the neutral species, is added to the gas causing ionization and the production of ions and electrons. The energy can be in the form of an externally applied electromagnetic field, electrostatic field, or heat. Plasma becomes an electrically conducting medium in which there are roughly equal numbers of positively and negatively charged particles, produced when the atoms/molecules in a gas become ionized.

A plasma discharge is produced when an electric field of sufficient intensity is applied to a volume of gas. Free electrons then are accelerated to sufficient energies to produce electron-ion pairs through inelastic collisions. As the density of electrons increase, further inelastic electron atom/molecule collisions will result in the production of further charged carriers and a variety of other species. The species may include excited and metastable states of atoms and molecules, photons, free radicals, molecular fragments, and monomers.

The term “metastable” describes a type of atom/molecule excited to an upper electronic quantum level. Here, quantum mechanical selection rules forbid a spontaneous transition to a lower level. As a result, such species have long, excited lifetimes. For example, whereas excited states with quantum mechanically allowed transitions typically have lifetimes on the order of about 10⁻⁹ to 10⁻⁸ seconds before relaxing and emitting a photon, metastable states can exist for about 10⁻⁶ to 10¹ seconds. The long metastable lifetimes allow for a higher probability of the excited species to transfer their energies directly through a collision with another compound and result in ionization and/or dissociative processes.

Plasma species are chemically active and/or can physically modify the surface of materials and may therefore serve to form new chemical compounds and/or modify existing compounds. For example, plasma species can modify existing compounds through ionization, dissociation, oxidation, reduction, attachment, and recombination.

A non-thermal, or non-equilibrium, plasma is one in which the temperature of plasma electrons is higher than the temperature of the ionic and neutral species. Within atmospheric pressure, non-thermal plasma, there is typically an abundance of the aforementioned energetic and reactive particles (i.e., species), such as ultraviolet photons, excited and/or metastable atoms and molecules, atomic and molecular ions, and free radicals. For example, within air plasma, there are excited, metastable, and ionic species of N₂, N, O₂, O, free radicals such as OH, HO₂, NO, O, and O₃, and ultraviolet photons ranging in wavelengths from 200 to 400 nanometers resulting from N₂, NO, and OH emissions. In addition to the energetic (i.e., fast) plasma electrons, embodiments harness and use these “other” particles to clean and surface-condition portions of liquid handling devices, such as probes, and the like. Although, plasma treatment permits multiple uses of a single substrate, it also affects the substrate such that it limits a usable life. These effects can be quantified and predicted, thus, by employing Near Infrared (NIR) electromagnetic energy, the apparatus can assess and track the useful, remaining life of a particular substrate.

A spectrophotometer is known as an instrument that illuminates a sample under test with electromagnetic energy (e.g., visible light, infrared (IR), near infrared (NIR), etc.), and measures an amount of electromagnetic energy of a specified wavelength, or across a spectral bandwidth, of a signal that passes through the sample under test. A substance will have a predetermined spectral signature when analyzed with spectrophotometry. According to Beer's law, the amount of light absorbed by a medium is proportional to the concentration of the absorbing material or solute present. Therefore, concentration of a substance in the sample under test is indicated by the strength of the spectral signature.

The output of a spectrophotometer can be complex to analyze, as peaks are hard to differentiate and many common analytic processes attempt to discover or confirm concentrations of specific molecules. However, embodiments in accordance with the present disclosure are able to use spectrophotometry as a useful diagnostic tool for certain purposes. In particular, embodiments use spectrophotometry within a predetermined wavelength range, the range chosen to include wavelengths at which a substrate material has a low response, i.e., the substrate material may be substantially transparent to those wavelengths. For example, the type of substrate material often used for labware is substantially transparent to NIR wavelengths. The certain purposes to use NIR wavelengths for a sample under test may include to detect a response, if any, from any materials present in the sample, other than the substrate.

One exemplary cleaning and treating apparatus (e.g., Applicant's PLASMAKNIFE™), used for labware, rinses and plasma treats substrates such as fluid dispensing devices (e.g., pipettes, tips, etc.) or fluid handling devices (e.g., microplates, etc.) so they are effectively renewed to a like new condition. In order to clean labware, plasma is drawn inside labware and then expelled. This process is typically operated for 30 seconds and causes disassociation of molecules and/or atoms of the contaminants present inside labware. Fluid dispensing devices and fluid handling devices may be referred to herein generically as substrates. As described herein, an NIR sensor and software is implemented within the system to collect and analyze data to allow an evaluation of any contaminants remaining as well as the surface condition of the substrate, which is oxidized by the plasma treatment process. Although plasma treatment removes only a very small layer of the substrate surface, over repeated reuse the substrate surface will be degraded and eventually will be unacceptable for further use.

In some applications described herein, there is no need to identify a particular molecule or to quantify the level of its concentration. In the context of cleaning operations, the presence of any substance other than the expected substrate indicates a contaminated surface. Thus, NIR spectroscopy can be employed in an uncomplicated manner to determine whether a substrate has been effectively cleaned or not.

In the context of plasma treatment, the use of NIR spectroscopy with existing plasma treatments is a new combination of technologies. The plasma treatment process conceptually “renews” the surface of a plastic labware substrate being treated by energizing and breaking down some of the polymer material, which reacts with ozone and other active species in the plasma and post plasma gas. Surface contamination is ionized or volatized and once in the gas phase, organic molecules are ionized, react with ozone, high energy oxygen and other reactive species in the plasma or post plasma gases, resulting in cleaning the substrate. The process also changes the surface energy of the remaining polymer material, as evidenced by a change in contact angle measurements of the material. Thus, although plasma treatment permits multiple uses of a single substrate, it also affects the substrate such that it has a limited usable life. These effects can be quantified and predicted. Thus, by employing NIR spectroscopy, embodiments in accordance with the present disclosure can assess and track the useful life, and remaining life of a particular substrate, including that of any desired films or coatings that may be on the substrate surface.

Polymer degradation of the plasma-treated plastic labware substrate will be measured by NIR spectroscopy, and the measured NIR data is used for two purposes. First, the measured NIR data is used as a background baseline correction factor to allow the much smaller signal of trace contamination remaining from the NIR spectroscopy process to be measured. This is feasible and important because only a few plastics are used in common labware, and all have extensive scan data available for both new and plasma-treated substrates. With the NIR scan data corrected by the known baseline, otherwise indistinguishable small scan changes caused by trace material can be easily detected. In one embodiment, an NIR data scan is collected for each piece of labware, for each treatment with plasma, over a useful life of the piece of labware. Each NIR data scan becomes a reference for the next NIR data scan of the same piece of labware, i.e., after successive treatments for both the effect of plasma on the labware surface and for a baseline of comparison for contamination determination purposes.

This use of NIR spectroscopy facilitates detecting a presence of low concentrations of trace substances, even where such substances might not be identifiable in an NIR scan. The presence of any peak not due the condition of the plastic labware surface, whether new or due to plastic degradation, is deemed to be evidence of contamination without a need to identify what kind of contamination.

Embodiments may scan a substrate by use of an NIR spectrophotometer, in order to check whether any contamination remains on a surface of the substrate. Other similar techniques to detect contamination on a substrate may also be used. The NIR spectrophoto-meter may be used to analyze and/or to confirm whether contamination is present or not on the surface of the substrate. In addition, the NIR spectrophotometer may be used to collect and analyze data to evaluate contamination remaining as well as the surface condition of the substrate.

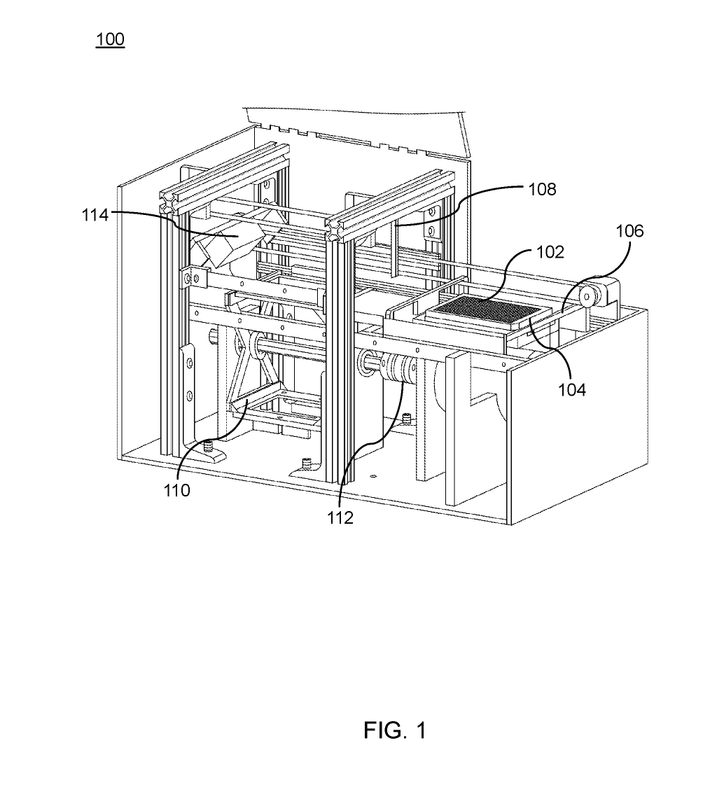

FIG. 1 illustrates an isometric view of cleaning device 100 to clean a substrate, according to an embodiment of the present invention. Cleaning device 100 cleans substrate 102 to remove contamination from its surface. Substrate 102 may comprise labware or a plastic material. The plastic may be, but is not restricted to, polystyrene, a silicone resin, and the like. The method and apparatus described herein are adaptable to many types of equipment. Labware may be, but is not restricted to, a sample-holding device, a sample-handling device, a fluid holding device, a fluid handling device, and the like. The fluid handling device may include, but is not restricted to, a pipette, a tip, a probe, a dropper, and the like. The fluid holding device may include, but is not restricted to, a microplate, a test tube, a microtube, and the like. The microplate is usually a small, plastic reaction vessel. The microplate has a tray covered with wells that are arranged in orderly rows. These wells are used to conduct separate chemical reactions during a fluid testing step. Microplates are ideal for high-throughput screening and research. They allow miniaturization of assays and are suitable for many applications, including drug testing, genetic study, and combinatorial chemistry.

Further, a unique identifier is provided to substrate 102. A unique identifier may be, but is not restricted to, an alphanumerical value (e.g., “ABC123”), a bar code, QR code, RFID tag, or a combination thereof. The unique identifier may be associated with the microplate in order to trace data associated with substrate 102 after every treatment from a database. When the microplate reaches the end of its useful life, it can be taken out of rotation and noted. Over time, a useful data base can be established, based on real life usage, to predict the expected useful life of the microplate.

Substrate 102 such as a microplate, is placed in a loading tray 104 of cleaning device 100. Loading tray 104 may be moved by a pushing mechanism 106. In some embodiments, loading tray 104 may be a part of pushing mechanism 106. In some other embodiments, loading tray 104 may be may be externally connected to pushing mechanism 106. The pushing mechanism 106 may push in and pull out loading tray 104 into a treatment area, operating under either automated or manual control of pushing mechanism 106. In the exemplary device of FIG. 1, the microplate is pushed into a centrifuge and exposed to a water knife. Once cleaned, the microplate is spun in the centrifuge to remove residual contaminants and water. In some embodiments, the microplate may also be plasma treated at this point, or that may occur subsequently or in a separate apparatus. Once the treatment is completed, the microplate then passes through the NIR scanner again and may be retrieved for future use.

It should be noted, that FIG. 1 depicts a water knife, but a similar apparatus is also used for plasma treatment, whereby the substrate, e.g., a microplate, is passed through an NIR either or both before and after plasma treatment.

In an exemplary scenario, in operation, substrate 102 is placed in a deck mounted wash station. In an automated microplate fluid handling apparatus, the apparatus performs an assay test. Then, at least the probe tips of the fluid handling device require cleaning. As such, the fluid handling device enters the wash station (i.e., the treatment area).

NIR sensor 108 may be located within or adjacent to the treatment area. In some embodiments of the present invention, there may be multiple NIR sensors 108. NIR sensor 108 scans substrate 102 in order to take readings of substrate 102 as it passes into and/or out of the treatment area. Those of skill in the art will readily appreciate the requirements to mount such an NIR sensor 108. NIR sensor 108 transmits NIR signals to substrate 102. An analyzer may be used to measure spectral content of a signal interacting with substrate 102 (e.g., by passing through substrate 102, or reflecting from substrate 102, etc.). From the spectral shape of the signal, the presence or identity of an element or molecular fragment may be determined.

In some embodiments of the present invention, NIR sensor 108 may be, but is not restricted to, a Near Infrared spectrophotometer. Those of skill in the art will readily appreciate the desirability to use any known or future technology that may cover a spectral wavelength range of about 200 nanometers to about 2,000 nanometers. In some embodiments, when substrate 102 passes into the treatment area, NIR sensor 108 scans substrate 102. The analyzer measures a spectrum of a signal interacting with substrate 102. Further a processing device, such as a processor, generates pre-cleaning data for substrate 102. In some embodiments, the pre-cleaning data may include, but is not restricted to, concentration of contaminants, a number of contaminants, a type of contaminant, a percentage value of contaminants present, and the like. The pre-cleaning data may then be associated with the unique identifier provided to substrate 102.

The treatment area may include a centrifuge 110 that spins substrate 102 in order to remove residual contaminants from the surface of substrate 102 after testing. Centrifuge 110 may have racks on which loading tray 104 holding substrate 102 is placed. In some embodiments of the present invention, centrifuge 110 may have two racks that spin two substrates simultaneously. In some embodiments, centrifuge 110 may have multiple racks such as four, six, or eight racks to spin four, six, or eight substrates at a time. Centrifuge 110 may be rotated by using a centrifuge motor 112 attached in the treatment area.

Further, substrate 102 is exposed to a water knife 114 within the treatment area, in some embodiments of the present invention. Water knife 114 may break up contaminants within wells of substrate 102, which aid in removing the contaminants from substrate 102. Water knife 114 targets a high-pressure jet of water on substrate 102, which breaks up the contaminants into pieces and removes the contaminants from substrate 102. Therefore, the rinse and spin of substrate 102 in centrifuge 110 along with the water knife 114 removes the contaminants. In some embodiments, the rinse and centrifugation may take approximately 40 to 45 seconds to process (i.e., cleaning) substrate 102.

Further, in some embodiments of the present invention, substrate 102 may be treated with plasma at this point in order to clean the surface of substrate 102 of contamination. In some other embodiments, substrate 102 may be plasma treated at a subsequent step in the treatment area. In yet another embodiment, substrate 102 may be plasma treated in another device (not shown). Plasma treatment may take approximately 30 seconds resulting in all material being ionized and removed from the surface of substrate 102.

In some embodiments of the present invention, the treatment (i.e., centrifuge, water knife, and plasma) of substrate 102 may take approximately 45 seconds. The time taken in the treatment of substrate 102 may be based on parameters, but is not restricted to, a rinse pressure, a spin speed, an air flow rate, and so forth. In an exemplary scenario, substrate 102 may require more time for the treatment as it may need gentle processing having parameters such as, a lower rinse pressure, a slow spin speed, a low air flow rate, and so forth.

After cleaning of substrate 102 in the treatment area, substrate 102 is scanned again by NIR sensor 108. In some embodiments of the present invention, when substrate 102 is removed from the treatment area, NIR sensor 108 scans substrate 102 again. The analyzer measures the spectrum of an electromagnetic signal returned from (or transmitted through) the surface of substrate 102. A deviation of the measured spectrum from a baseline, substrate-only spectrum indicates that a contaminant still is present, and the shape of the measured spectrum may be further processed to identify the contaminant and/or its concentration. Further, the processing device, such as a processor, generates post-cleaning data for substrate 102. In some embodiments, the post-cleaning data may include, but is not restricted to, whether a contaminant is present, concentration of contaminants, a number of contaminants, a type of contaminant, a percentage value of contaminants present, and the like.

Further, the pre-cleaning data and the post-cleaning data are compared in order to generate contamination characteristics associated with the contaminants present on substrate 102. In some embodiments of the present invention, the comparison between the pre-cleaning data and the post-cleaning data may be done by a processing device. The contamination characteristics may include, but is not restricted to, a concentration of contamination, a type of contamination, a percentage value of contaminant, and the like.

Further, the pre-cleaning data and the post-cleaning data associated with substrate 102 are updated in database 205 at steps 206, 212. In some embodiments of the present invention, if substrate 102 is being treated for a first time, then substrate 102 may be assigned a unique identifier and its pre-cleaning data and post-cleaning data may be stored as a new entry in a database.

Furthermore, the pre-cleaning data and the post-cleaning data may be analyzed in order to generate one or more patterns. From this data, patterns can be established predicting the number of plasma cycles in the life of a particular microplate (or the useful life of a microplate associated with a particular type and supplier.) The patterns may predict a number of plasma cycles in the life of a substrate, or may predict a useful life of a substrate associated with a particular type, a supplier, or a combination thereof.

Moreover, based on the analysis of the pre-cleaning data and the post-cleaning data, an effect of the cleaning on a substrate is predicted. For example, based on historical data stored in the database for a first through ninth cleaning, embodiments may predict how the spectrum of a contamination-free substrate 102 should look after a tenth cleaning process, e.g., by extrapolating a trend identified in the first through ninth cleanings. In some embodiments of the present invention, the predicted effect of an additional treatment may be computed via a difference between a historical NIR pre-cleaning data and post-cleaning data. For example, if the as-measured characteristics after the tenth cleaning of a clean substrate 102 deviates from the predicted characteristics (e.g., as predicted by use of the trend identified from the first through ninth cleanings), then the trend can be recomputed using measured data from the tenth cleaning, and an improved prediction may be calculated for the eleventh cleaning, using the recomputed trend.

The effect of a contaminant is treated on a case-by-case basis. In some embodiments of the present invention, the detection of a contaminant may indicate an operator error in the cleaning procedure, corrected by simply re-running the process. In some other embodiments of the present invention, detection of a contaminant may indicate the need to replace a particular microplate. In still other embodiments, the detection of a contaminant may indicate a need to service or perform maintenance on the cleaning equipment itself (i.e., cleaning device 100).

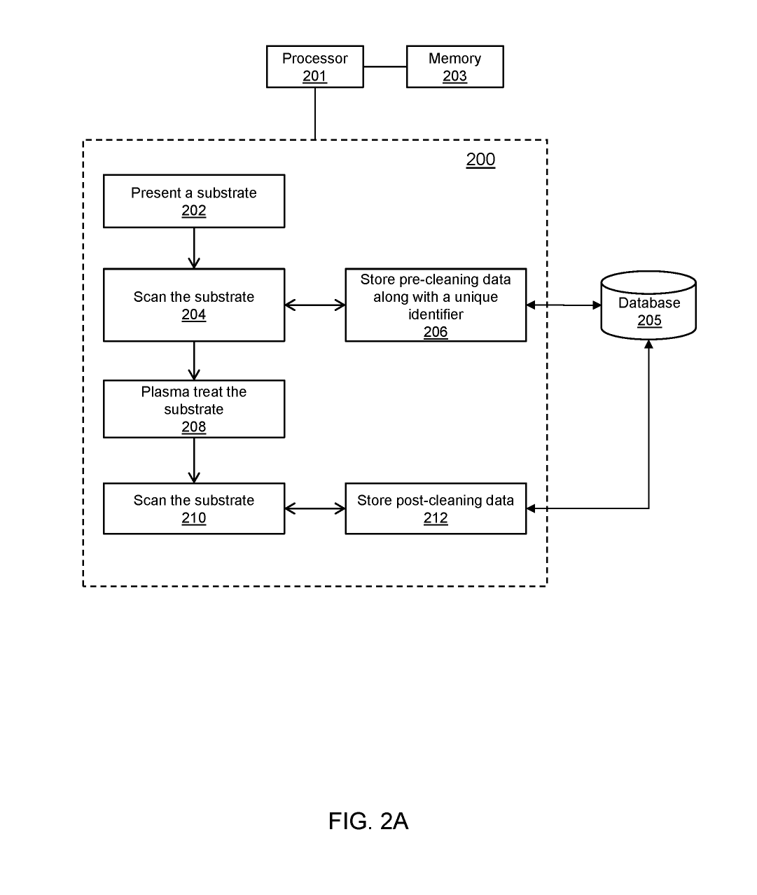

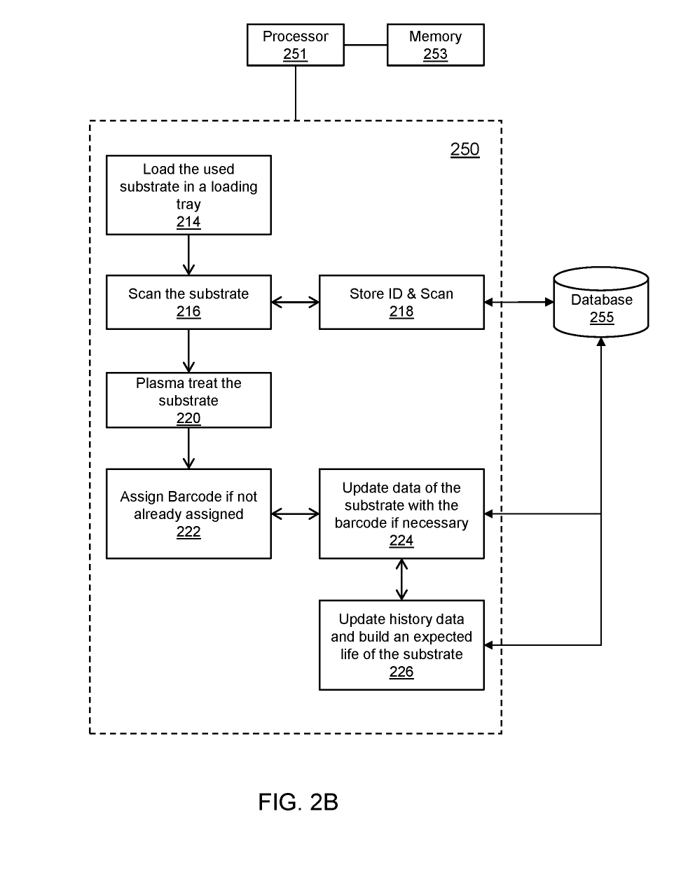

FIG. 2A depicts a block diagram of a method 200 to scan a substrate, according to an embodiment of the present invention. Method 200 is implanted by a processor 201, which executes sets of programmed instructions stored in a memory 203 communicatively coupled to processor 201. The sets of programmed instructions, when executed by processor 201, provide the steps of method 200. Processor 201 is also communicatively coupled to database 205 described below.

At step 202, a new substrate (e.g., a microplate) is loaded in a tray, such as loading tray 104.

At step 204, the substrate is scanned by a NIR scanner such as NIR sensor 108. The NIR scanner scans the substrate by exposing the substrate to NIR electromagnetic energy. When the electromagnetic energy passes through the substrate, a detected transmissive signal through the substrate may be analyzed to determine whether a surface of the substrate is clean, or whether the surface includes contaminants. If unexpected spectral changes occur to the electromagnetic energy passing through the substrate, then it may be determined that contaminants are present on the surface of the substrate. The NIR scanner then transmits pre-cleaning data to database 205.

With increased usage, database 205 for a particularly type and supplier may be established and improved so that new microplates can be assumed to have known properties thus reducing the need to evaluate each new microplate.

At step 206, database 205 stores the scanned pre-cleaning data with a unique identifier. As discussed, the unique identifier may be, but is not restricted to, a numerical value, a series of alphabets, a bar code, or a combination thereof. In some embodiments of the present invention, database 205 may be established for a particular supplier and/or manufacturer, or a type of substrate, and the like. Database 205 may store a baseline for substrates that need to be evaluated before and/or after every treatment.

At step 208, the substrate is plasma treated in order to remove contaminants from the surface of the substrate. Plasma treatment may take approximately 30 seconds, resulting in substantially all material being ionized and removed from the substrate.

At step 210, the substrate is scanned again to generate post-cleaning data associated with the substrate. As discussed, the post-cleaning data may include, but is not restricted to, whether a contaminant is present, concentration of contaminants, a number of contaminants, a type of contaminant, a percentage value of contaminants present, and the like.

At step 212, post-cleaning data is stored in database 205. Pre-cleaning data and post-cleaning data are analyzed to determine and/or predict effect of plasma cycles on a substrate. In an exemplary scenario, a bar code (or other identifier, RFID, etc.) can be used with a predetermined substrate so that its data may be tracked from one treatment to the next. When the substrate reaches the end of its useful life, it can be taken out of rotation and noted. Over time, a useful database can be established, based on real life usage, to predict an expected useful life of the substrate.

FIG. 2B depicts a block diagram of a method 250 to scan a substrate after usage, according to an embodiment of the present invention. Method 250 is implanted by a processor 251, which executes sets of programmed instructions stored in a memory 253 communicatively coupled to processor 251. The sets of programmed instructions, when executed by processor 251, provide the steps of method 250. Processor 251 is also communicatively coupled to database 255 described below.

At step 214, a used substrate is loaded into loading tray 104 in order to undergo a treatment process. At step 216, the used substrate goes through a pre-cleaning scanning process, storing the scanned pre-cleaning data in database 255 at step 218, and then the substrate undergoes a plasma treatment at step 220.

Further, at step 222, a unique identifier (e.g., a barcode) is assigned to the substrate if one is not already assigned.

Next, at step 224, database 255 of pre-cleaning substrate data and the post-cleaning substrate data is updated to include the pre-cleaning data and the post-cleaning data associated with the new unique identifier.

At step 226, database 255 is updated to include a batch history of the substrate. The batch history may indicate, but is not restricted to, number of times the substrate underwent the treatment process during one treatment process, number of times the substrate underwent the treatment process in its useful life, and the like. A target expected life of the substrate may be computed based on the batch history of the substrate stored in database 255.

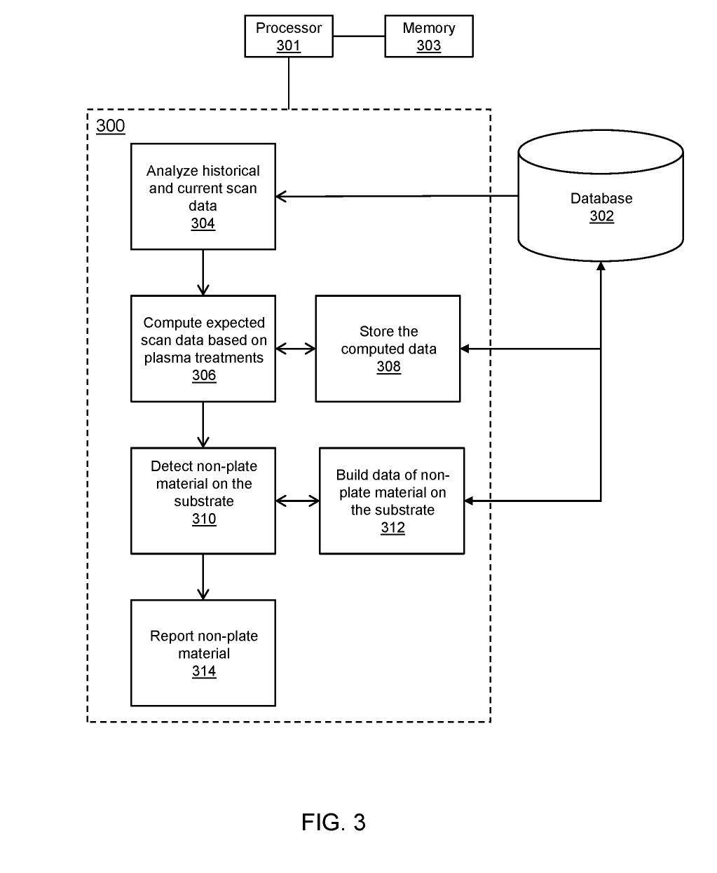

FIG. 3 depicts a flowchart of a method 300 to detect one or more contaminants on a surface of substrate 102 by employing a NIR sensor, according to an embodiment of the present invention. Method 300 is implanted by a processor 301, which executes sets of programmed instructions stored in a memory 303 communicatively coupled to processor 301. The sets of programmed instructions, when executed by processor 301, provide the steps of method 300. Processor 301 is also communicatively coupled to database 302 described below.

Database 302 stores scanned pre-cleaning data and post-cleaning data associated with substrate 102. As discussed above, the pre-cleaning data and the post-cleaning data may include, but is not restricted to, concentration of contaminants, a number of contaminants, a type of contaminant, a percentage value of contaminants present, and the like.

At step 304, stored historical pre-cleaning data and post-cleaning data associated with substrate 102 and the current scanned pre-cleaning data and the post-cleaning data associated with the substrate under treatment is retrieved from database 302 and is analyzed, according to an embodiment of the present invention.

The historical data of the substrate being cleaned, and a predictive effect of the next cleaning cycle (N+1), together form a new baseline against which non-plate materials can be assessed, wherein N is a number of times a substrate underwent a treatment process. Therefore, at step 306, based on analysis of historical pre-cleaning data, embodiments establish a new baseline using general historical data, or using data specific to a particular microplate, or using both. This facilitates detection of minute quantities of contaminants. Subtracting a known or calculated baseline from a new NIR scan can identify the presence of a contaminant, without a need to identify the detected the contaminant or its components. Anything that remains above baseline is deemed to be evidence of a contaminant.

In some embodiments, a plate may include desired films or coatings (generically, coatings). For some purposes (e.g., detecting contaminants), a plate material may be deemed to include desired coatings, such that a search for any non-plate materials excludes spectral signatures or other effects due to the desired coatings. In other circumstances (e.g., to detect a state of the coating itself, such as a remaining thickness), the plate material may be deemed to exclude the desired coating, such that a search and/or characterization of non-plate materials may include analysis of a spectral signature or other effects due to the coating.

At step 308, the computed expected scan is stored in database 302. Step 308 may also improve the sub-process of predicting the effect of the next cleaning cycle (N+1) by comparing how the present scan compared to the previous prediction of the scan. For example, if the present NIR scan has a higher or lower NIR scan spectrum than predicted, then a prediction for the (N+1) cleaning cycle may be adjusted upward or downward, respectively.

Next, at step 310, embodiments may detect a non-plate material a surface of the substrate. The non-plate material may be a material that is present on the surface of the substrate other than the substrate material. The non-plate material may be detected as a deviation from the new baseline established using either or both general historical pre-cleaning data and post-cleaning data or data specific to a particular substrate such as a microplate. Detecting the presence of a deviation is sufficient, without specifically identifying or characterizing the deviation, or mapping the deviation to chemical components that match a signature of the deviation. There is no need to identify the detected components, since knowing the component will not affect how the contaminated substrate will be handled. Therefore, anything that remains above the baseline may be considered as non-plate material i.e., a contaminant.

The presence of any non-plate material indicates the presence of a contaminant, and thus ineffective cleaning. Embodiments may deal with ineffective cleaning in at least one of several ways. Some embodiments may select how to deal with ineffective cleaning based upon an amount, concentration, or mere presence of detected contaminant. For example, if the detected concentration does not exceed a first, relatively low threshold, then a cleaning process may be repeated with substantially the same process settings (e.g., plasma strength, time length of treatment, etc.). If the detected concentration exceeds the first threshold but does not exceed a second, relatively higher threshold, then the cleaning process may be repeated with stronger or more vigorous treatment settings (e.g., stronger plasma strength, longer treatment time, etc.). In some embodiments, an increase in the strength of the treatment settings may depend upon or be proportional to an amount by which the detected concentration of contaminant exceeds the first threshold. For example, if T1 and T2 are first and second threshold concentrations, and C1 and C2 are two detected concentrations of contaminant, and if the values have a mathematical relationship T1<C1<C2<T2, then a re-cleaning time at concentration C2 may be longer than a re-cleaning time at concentration C1. In some embodiments, if the detected concentration exceeds a third threshold concentration, higher than the second threshold concentration, then substrate 102 may be discarded or marked as being unusable. The re-cleaning will take place before substrate 102 can be used again. In some embodiments, the re-cleaning may take place substantially immediately after a spectrophotometric measurement.

Some embodiments may alter a cleaning process based upon detected concentrations of contaminant remaining on substrate 102 after a first or subsequent re-cleaning, or upon a rate at which detected concentrations of contaminant changes from one re-cleaning to another. For example, if after a first re-cleaning an amount of detected contaminant has not significantly changed, then substrate 102 may be discarded or marked as being unusable. In another example, if an amount of detected contaminant after a re-cleaning decreases by at least a predetermined amount (e.g., a percentage of the detected contaminant) but is still higher than the first threshold, then the re-cleaning may be repeated another time, using either the same or altered process settings. In some embodiments, if the rate of decrease in detected contaminant is such that the remaining contaminant should be less than the first threshold within a predetermined total number of re-cleanings, then re-cleanings may continue. In some embodiments, a decision to re-clean may depend upon observed changes to substrate 102 itself rather than or in addition to any observed contaminants.

At step 312, the established baseline and the detected non-plate materials are stored in database 302, which then builds datapoints associated with the non-plate materials.

Next, at step 314, detection of non-plate material may be reported to a machine operator or analyst (e.g., a local machine status indicator or terminal interface; or remotely by email, text message, instant message, desktop notification, etc.) for further attention such as additional cleaning.

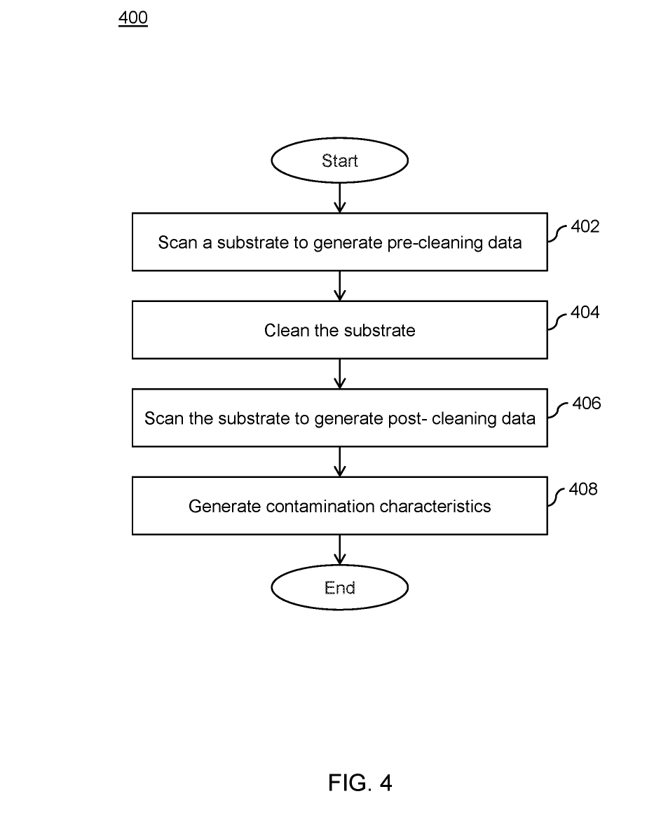

FIG. 4 depicts a flowchart of a method 400 to clean a substrate (e.g., substrate 102), according to another embodiment.

At step 402, the substrate under treatment may be scanned. In an embodiment, the substrate is first scanned before it undergoes a treatment process. Substrate is scanned by using a first mechanism, such as a NIR sensor. In some embodiments, the NIR sensor may be a NIR spectrophotometer. Further, a pre-cleaning data associated with the scanning is generated. As discussed, pre-cleaning data may include, but is not restricted to, concentration of contaminants, a number of contaminants, a type of contaminant, a percentage value of contaminants present, and the like.

Next, at step 404, the substrate is then cleaned by using a second mechanism in a treatment area. The second mechanism may be, but is not restricted to, a centrifuge, a water knife, or a combination thereof. The centrifuge may have racks on which a loading tray holding the substrate is placed. The centrifuge spins the substrate and breaks down the material present on the surface of the substrate. The water knife sprays water on the surface of the substrate to remove the material, i.e., non-plate material.

At step 406, the substrate after cleaning is re-scanned, according to an embodiment of the present invention. Substrate 102 is re-scanned by using the first mechanism, such as a NIR sensor. In some embodiments, the NIR sensor may be a NIR spectrophotometer. Further, a post-cleaning data associated with the scanning is also generated. As discussed above, the post- cleaning data may include, but is not restricted to, whether a contaminant is present, concentration of contaminants, a number of contaminants, a type of contaminant, a percentage value of contaminants present, and the like.

Further, at step 408, the pre-cleaning data and the post-cleaning data are analyzed to generate one or more contamination characteristics associated with the contaminants present on the substrate. Contamination characteristics may include, but is not restricted to, whether a contaminant is present, a concentration of contamination, a type of contamination, a percentage value of contaminant, and the like.

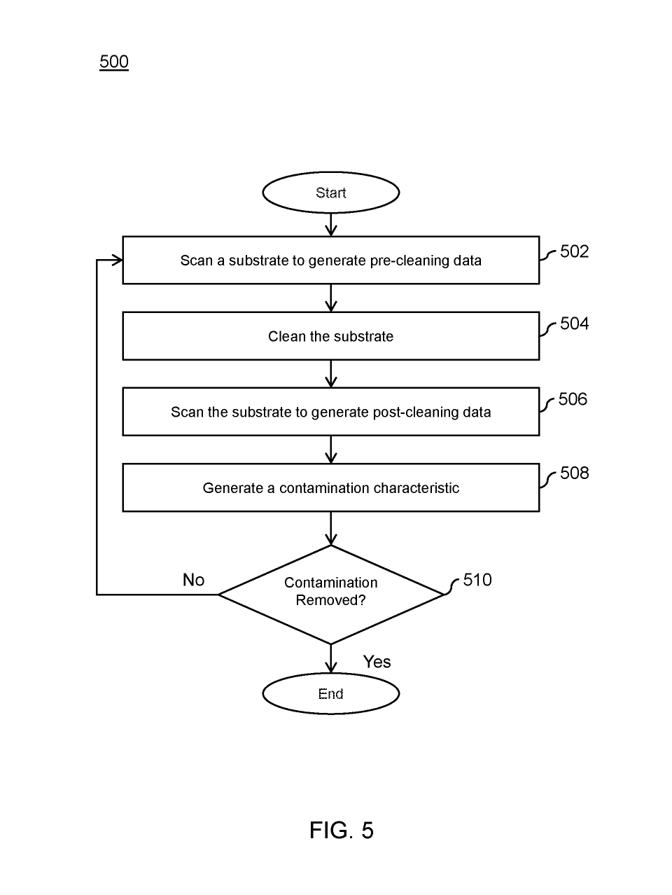

FIG. 5 depicts a flowchart of a method 500 to clean a substrate, according to another embodiment of the present invention.

At step 502, substrate 102 under treatment is scanned. In an embodiment of the present invention, substrate 102 is first scanned before it undergoes a treatment process. Substrate 102 is scanned by using a first mechanism, such as a NIR sensor. In some embodiments, the NIR sensor may be a NIR spectrophotometer. Further, a pre-cleaning data associated with the scanning is generated. As discussed, the pre-cleaning data may include, but is not restricted to, a concentration of contaminants, a number of contaminants, a type of contaminant, a percentage value of contaminants present, and the like.

Next, at step 504, substrate 102 is cleaned by using a second mechanism in a treatment area. The second mechanism may be, but is not restricted to, a centrifuge, a water knife, or a combination thereof. The centrifuge may have racks on which a loading tray holding substrate 102 is placed. The centrifuge spins substrate 102 and breaks down the material present on the surface of substrate 102. The water knife sprays water on the surface of substrate 102 to remove the material, i.e., non-plate material.

At step 506, substrate 102 after cleaning is re-scanned, according to an embodiment of the present invention. Substrate 102 is re-scanned by using the first mechanism, such as a NIR sensor. In some embodiments, the NIR sensor may be a NIR spectrophotometer. Further, a post-cleaning data associated with the scanning is also generated. As discussed, the post-cleaning data may include, but is not restricted to, concentration of contaminants, a number of contaminants, a type of contaminant, a percentage value of contaminants present, and the like.

Further, at step 508, the pre-cleaning data and the post-cleaning data are analyzed to generate one or more contamination characteristics associated with the contaminants present on substrate 102. The contamination characteristics may include, but is not restricted to, whether a contaminant is present, a concentration of contamination, a type of contamination, a percentage value of contaminant, and the like.

At step 510, a predicted effect is determined by determining whether any contamination is still present on the surface of substrate 102. If contamination is still present on the surface of substrate 102, then method 500 returns to step 502. In some embodiments of the present invention, the subsequent treatment of substrate 102 may be repeated another time. Substrate 102 may be cleaned up to about 10,000 times over a useful lifetime of substrate 102. If no contamination is present on the surface of substrate 102, then method 500 concludes. In some embodiments, the determination of the contaminants may be based on the analysis of the pre-cleaning data and the post-cleaning data. The analysis may be done by subtracting the pre-cleaning data from the post-cleaning data, in an exemplary scenario.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The exemplary embodiments of this present invention have been described in relation to a laboratory equipment. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and/or reducing cost of implementation.

The foregoing discussion of the present invention has been presented to illustrate and describe certain embodiments. It is not intended to limit the present invention to the form or forms disclosed herein. In the foregoing detailed description, for example, various features of the present invention may be grouped together in one or more embodiments, configurations, or aspects in order to streamline the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method to clean a substrate, the method comprising:
presenting an identified substrate for cleaning, wherein the identified substrate is associated with recorded near infrared (NIR) spectrophotometric data based on the identified substrate;
cleaning the identified substrate;
scanning, with an NIR spectrophotometer, the cleaned identified substrate to obtain new NIR spectrophotometric data for the cleaned identified substrate; and
comparing the new identified substrate NIR spectrophotometric data to the recorded NIR spectrophotometric data to identify any non-plate material data.

2. The method of claim 1, further comprising the step of:
identifying any non-plate material data as an indication of a contaminant.

3. The method of claim 1, wherein the comparing step also accounts for a predicted effect of the cleaning step.

4. The method of claim 1, further comprising the steps of:
identifying the substrate by use of a unique identifier; and
associating the new identified substrate NIR spectrophotometric data and the recorded NIR spectrophotometric data to the unique identifier.

5. The method of claim 1, further comprising
updating a database to include the new identified substrate NIR spectrophotometric data and the recorded NIR spectrophotometric data; and
generating a pattern based on the comparison of the new identified substrate NIR spectrophotometric data to the recorded NIR spectrophotometric data.

6. The method of claim 5, wherein the pattern indicates one of a number of remaining cleaning cycles of the cleaned identified substrate and a useful life of the cleaned identified substrate.

7. The method of claim 1, further comprising:
predicting an effect of a subsequent cleaning on the cleaned identified substrate based on the comparison of the new identified substrate NIR spectrophotometric data to the recorded NIR spectrophotometric data.

8. The method of claim 1, wherein substrates comprises one of a sample holding device, a fluid handling device, and a fluid holding device.

9. The method of claim 1, further comprising the steps of:
re-cleaning the identified substrate if the new identified substrate NIR spectrophotometric data indicates presence of a contaminant.

10. The method of claim 1, further comprising the steps of:
adjusting a cleaning process setting based upon a characteristic of the cleaned identified substrate; and
re-cleaning the identified substrate using the adjusted cleaning process setting.

11. The method of claim 1, further comprising the steps of:
adjusting a cleaning process setting based upon a comparison of the new identified substrate NIR spectrophotometric data to the recorded NIR spectrophotometric data; and
re-cleaning the identified substrate using the adjusted cleaning process setting.

12. The method of claim 10, wherein the adjusted cleaning process setting depends upon the new identified substrate NIR spectrophotometric data.

13. The method of claim 10, wherein the adjusted cleaning process setting depends upon a magnitude of a difference between the new identified substrate NIR spectrophotometric data to the recorded NIR spectrophotometric data.

14. A method of evaluating the useful life a substrate to be treated, the method comprising:
providing a unique identifier to a substrate to produce an identified substrate;
subjecting the identified substrate to near infrared (NIR) spectrophotometry;
recording spectrophotometric data from the NIR spectrophotometry to produce pre-treatment spectrophotometric data;
associating the recorded spectrophotometric data with the identified substrate;
treating the identified substrate to remove a contaminant, to produce a treated substrate;
subjecting the treated substrate to NIR spectrophotometry to produce post-treatment spectrophotometric data;
determining a treatment effect on the treated substrate by comparing the pre-treatment spectrophotometric data to the post-treatment spectrophotometric data.

15. The method of claim 14, further comprising:
subsequently treating the treated substrate to yield a subsequently treated substrate;
subjecting the subsequently treated substrate to NIR spectrophotometry to produce post-subsequent treatment spectrophotometric data;
determining an effect of subsequent treatment on the treated substrate by comparing the post-treatment spectrophotometric data to the post-subsequent treatment spectrophotometric data.

16. The method of claim 15, wherein the subsequently treating and determining steps are repeated from 1 to 10,000 times.

17. The method of claim 14, further comprising a step of calculating historical differences between previous post-treatment spectrophotometric data to produce a predictive effect of an additional treatment.

18. An apparatus to clean a substrate with improved assurance, the apparatus comprising:
a processor coupled to a memory and to a database, the memory configured to store sets of programming instructions;
a substrate cleaning chamber configured to clean a contaminant from a substrate;
a near infrared (NIR) spectrophotometer coupled to the chamber, the NIR spectrophotometer controlled by the processor to scan the substrate within a scan volume;
a transporter configured to transport the substrate between the chamber and the scan volume of the spectrophotometer;
wherein the processor is configured by a respective set of programming instructions:
to gather a first spectrum data from the NIR spectrophotometer before cleaning the contaminant from the substrate;
to gather a second spectrum data from the NIR spectrophotometer after cleaning the contaminant from the substrate; and
to analyze a difference between the first spectrum data and the second spectrum data.

19. The apparatus of claim 18, wherein the processor is further configured:
to determine a unique identity of the substrate;
to associate the first second spectrum data and the second spectrum data with the identity of the substrate; and
to store the first second spectrum data and the second spectrum data with the identity of the substrate in the database.

20. The apparatus of claim 18, wherein the processor is further configured:
to update at least one database based on the pre-cleaning data and the post-cleaning data; and
to generate one or more patterns based on the analysis of the pre-cleaning data and the post-cleaning data.
